(19) United States
(12) Patent Application Publication
(10) Pub. No.: US 2001/0016621 A1
(43) Pub. Date: Aug. 23, 2001

(54) Polyethylene composition

(76) Inventor: Shiu Yin Lau, Hong Kong (HK)

Correspondence Address: BAKER & BOTTS, 30 ROCKEFELLER PLAZA, NEW YORK, NY, 10112

(21) Appl. No.: 09/833,957

(22) Filed: Apr. 12, 2001

Related U.S. Application Data
(63) Continuation of application No. 09/032,531, filed on Feb. 27, 1998.

(51) Int. Cl. C08J 3/00

(52) U.S. Cl. 524/543; 524/430

(57) ABSTRACT

A polyethylene resin composition is prepared by first preparing a mixture by admixing the following components: (i) about 40-80% polyethylene, (ii) about 5-30% of a linear low density polyethylene prepared using a metallocene catalyst, (iii) about 1-10% of a low density polyethylene, and (iv) about 10-30% of a high density polyethylene and then heating the mixture at a temperature in the range of 80-120° C. for a time in the range of 0.45-1.5 hours. A polyethylene film composition is prepared by first preparing a mixture by admixing the following components: (i) about 40-80% polyethylene, (ii) about 5-30% of a linear low density polyethylene prepared using a metallocene catalyst, (iii) about 1-10% of a low density polyethylene, and (iv) about 10-30% of a high density polyethylene and then heating the mixture at a temperature in the range of 80-120° C. for a time in the range of 0.45-1.5 hours, and then introducing the mixture into a blown film apparatus and processing the mixture at a temperature in the range of 180-120° C. to obtain a polyethylene film.

### CROSS-REFERENCE TO RELATED APPLICATIONS

This application is a continuation of U.S. Ser. No. 09/032,531, filed on Feb. 27, 1998 which is incorporated by reference herein.

### BACKGROUND OF THE INVENTION

This invention relates to a polyethylene resin composition, a method of preparing such a resin composition, a polyethylene film composition, and a method of preparing such a film composition. The polyethylene film has good strength, rigidity, gloss, slip, low temperature resistance and sealability and may be used in the manufacture of bags, folders, and similar products.

It has long been desired to obtain materials for bags, folders and other products which have good strength and appearance. Although these products are sometimes made from paper or mixtures of paper and other materials, such products often lack the necessary strength and appearance. Accordingly, polyethylene materials have been employed. However, the film prepared from such materials often includes bubbles or sags, resulting in poor quality products and processing difficulties. In addition, typically such materials experience melt fracture surface properties or “sharkskin” surface melt fracture at relatively low extrusion rates leading to further processing difficulties.

### SUMMARY OF THE INVENTION

The polyethylene resin composition of this invention is prepared by the process comprising:

(a) preparing a mixture by admixing the following components:

(i) about 40-80% polyethylene,

(ii) about 5-30% of a linear low density polyethylene prepared using a metallocene catalyst,

(iii) about 1-10% of a low density polyethylene, and (

iv) about 10-30% of a high density polyethylene; and

(b) heating the mixture at a temperature in the range of 80-120° C. for a range of 0.45-1.5 hours.

The polyethylene resin composition may advantageously be employed in preparing a polyethylene film which may be used in bags, folders, and the like. The polyethylene film composition is prepared by the process comprising:

(a) preparing a mixture by admixing the following components:

(i) about 40-80% polyethylene,

(ii) about 5-30% of a linear low density polyethylene prepared using a metallocene catalyst,

(iii) about 1-10% of a low density polyethylene, and

(iv) about 10-30% of a high density polyethylene;

(b) heating the mixture at a temperature in the range of 80-120° C. for a range of 0.45-1.5 hours; and

(c) introducing the mixture into a blown film apparatus and processing the mixture at a temperature in the range of 180-210° C. to obtain a polyethylene film.

The polyethylene film may advantageously be prepared by employing a tube-shaped die with the blown film apparatus, so that a tube-shaped film is produced.

### BRIEF DESCRIPTION OF THE DRAWINGS

FIG. 1 depicts a “T-die” used in conjunction with a blown film apparatus sheet-shaped polyethylene film.

FIG. 2 depicts a “tube-shaped” die used in conjunction with a blown film apparatus to produce tube-shaped polyethylene film.

### DETAILED DESCRIPTION OF THE INVENTION

All concentrations described herein are on a weight % basis based upon the total weight of the mixture, unless otherwise specified. The polyethylene (PE) component of the resin is introduced into the resin mixture in a concentration range of about 40-80%, preferably about 50-75%. In a particularly preferred embodiment, the PE component is introduced into the resin mixture in concentration of about 60%. The PE has a melt flow rate of 1 to 2 g/min, and a density of 1 to 1.4 g/cm³. An example of PE which is commercially available and particularly preferred for use in this invention is the PAPERMATCH family of polyethylene products available from A. Schulman Inc. Ltd. of Guent, England.

The linear low density polyethylene (LLDPE) component of the resin is introduced into the resin mixture in a concentration range of about 5-30%, preferably about 10-20%. In a particularly preferred embodiment, the LLDPE component is introduced into the resin mixture in a concentration of about 12-15%, say 12%. The LLDPE may be a copolymer of ethylene and an alpha-olefin of 4 or more carbon atoms. LLDPE is generally known as a “linear” polymer because of the substantial absence of branched chains of polymerized monomer units pendant from the main polymer “backbone.” The amount of alkene comonomer is generally sufficient to cause the density of the LLDPE to be substantially in the same density range as low density polyethylene (LDPE), due to the alkyl side chains on the polymer molecule, yet the polymer remains in the “linear” classification. The LLDPE component is prepared using a metallocene catalyst. Suitable metallocene catalysts and process conditions and apparatus which may be used to prepare such LLDPE compositions are described, for example, in U.S. Pat. Nos. 5,324,800 (Ewen and Welborn), 5,272,236 (Lai et al.), 5,281,679 (Jejelowo et al.), and 5,420,220 (Cheruvu et al.), all of which are incorporated herein by reference. An example of LLDPE which is commercially available and particularly preferred for use in this invention is the EVOLUE metallocene LLDPE product available from Mitsui Sekka of Japan. This LLDPE is a copolymer of ethylene and alpha-olefin prepared in a gas-phase manufacturing process using a metallocene catalyst (which may include an alumoxane such as methylalumoxane). This LLDPE has a narrow molecular weight distribution (Mw/Mn) as measured by gel permeation chromatography (GPC) of about 1.5-3.5, a density in the range of about 0.90-0.94, preferably about 0.92 g/cm³, and a melt flow ratio (MFR) in the range of about 2 g/10 min. at a density of about 0.92 g/cm³.

The low density polyethylene (LDPE) component of the resin is introduced into the resin in a concentration of about 1-10%, preferably about 1-5%. In a particularly preferred embodiment, the LDPE component is introduced into the resin mixture in a concentration of about 3%. The LDPE component may optionally comprise 50-70% titanium dioxide, preferably about 60% by weight titanium oxide (based upon the total weight of the LDPE component). The LDPE component has a density of about 1710 kg/m³ at 23° C. and an MFI of 8 g/10 min. at 2.16 kg/190° C. An example of LDPE which is commercially available and particularly preferred for use in this invention is the PLASWITE PE 7024 product available from Cabot Corporation.

The high density polyethylene (HDPE) component of the resin is introduced into the resin mixture in a concentration range of about 10-30%, preferably about 20-25%. In a particularly preferred embodiment, the HDPE component is introduced into the resin mixture in a concentration of about 22-25%, say 25%. The HDPE component has a density in the range of 0.94-0.97 g/cm³, and may be characterized in that, if used alone, it yields a blown film having a density in the range of 0.95-0.96 g/cm³ and an MFR in the range of 0.03-0.05 at 190° C. An example of HDPE which is commercially available and particularly preferred for use in this invention is the HI-ZEX 7000F product manufactured by Mitsui Hi-Polymer (Asia) Ltd..

The resin may additionally comprise other additives known to those skilled in the art, such as pigments, dyes, stabilizers, antistatic agents, anti-slip agents, anti-blocking agents, anti-fogging agents, lubricants, dyes, nucleating agents, plasticizers, anti-aging agents, hydrochloric acid absorbent, antioxidants, and the like.

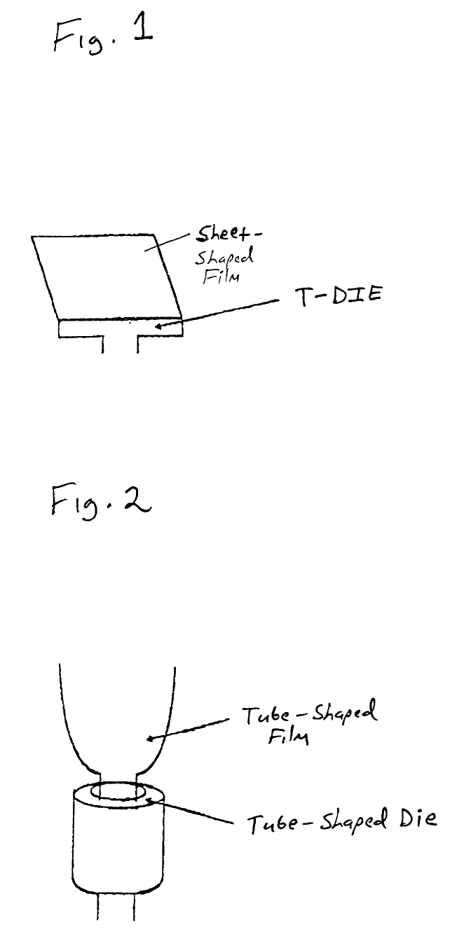

The resin may be further processed using conventional polymeric processing technology, such as injection molding, blow molding, extrusion, rotomolding, and blown film technology. Blown film fabrication conditions which may be used in this invention include conditions described, for example, in U.S. Pat. Nos. 5,370,940 (Hazlitt et al.) and 5,420,220 (Cheruvu et al.), incorporated herein by reference. In a particularly preferred embodiment, the resin is processed using a conventional blown film apparatus to yield blown polyethylene film. In one embodiment, a “T-die” (FIG. 1) may be used in conjunction with a conventional blown film apparatus to produce single sheets of the polyethylene film of this invention. In another embodiment, a tube-shaped die (FIG. 2) may be used in conjunction with a conventional blown film apparatus to produce tube-shaped sheets of the polyethylene film of this invention. As in the case of the resin, the film may additionally comprise other additives known to those skilled in the art such as pigments, stabilizers, antistatic agents, anti-slip agents, anti-blocking agents, anti-fogging agents, lubricants, dyes, nucleating agents, plasticizers, anti-aging agents, antioxidants, and the like.

The invention is further illustrated by the following examples:

### EXAMPLE 1

A polyethylene resin composition was prepared as follows. The following components were dry blended using a Henschel mixer or the like:

| | Concen- |
|---|---|
| Component | tration |
| Polyethylene (A. Schulman Inc. Ltd. PAPERMATCH T.4228) | 60% |
| LLDPE (Mitsui Sekka EVOLUE) | 12% |
| LDPE (Cabot Corp. PLASWITE PB 7024) | 3% |
| HDPE (Mitsui HI-ZEX 7000F) | 25% |

The mixture was dried at a temperature of about 120° C. for about one hour to prepare the polyethylene resin.

### EXAMPLE 2

The polyethylene resin of Example 1 was introduced into a conventional three-chambered blown film apparatus fitted with a tube-shaped die. The three chambers of the apparatus were heated to temperatures of 180° C., 180-190° C., and 180-190° C. respectively, and the tube-shaped die was heated to a temperature of 200-210° C. The film was fabricated on a modified blown film line using the following fabrication conditions:

55 mm extruder

6 inch die

1 mm die gap

400 RPM extruder speed

1:6 Blow up ratio

10-12 inches frost line height

The film properties of the film thus obtained were as follows:

Tensile yield (kg/cm²) 230

Tensile break (kg/cm²) 300

Elongation (%) >500

Flexural Modulus (kg/cm²) 10,600

Dart A (gm) 155

The polyethylene film obtained was tube-shaped, and was used to fabricate seamless-wall shopping bags having good strength, high moisture resistance and good appearance.

The invention claimed is:

1. A polyethylene resin composition prepared by the process comprising:
(a) preparing a mixture by admixing the following components:
(i) about 40-80% polyethylene,
(ii) about 5-30% of a linear low density polyethylene prepared using a metallocene catalyst,
(iii) about 1-10% of a low density polyethylene, and
(iv) about 10-30% of a high density polyethylene; and
(b) heating the mixture at a temperature in the range of 80-120° C. for a range of 0.45-1.5 hours.

2. The composition of claim 1, wherein about 50-75% of component (i) is employed.

3. The composition of claim 1, wherein about 10-20% of component (ii) is employed.

4. The composition of claim 1, wherein about 1-5% of component (iii) is employed.

5. The composition of claim 1, wherein about 20-25% of component (iv) is employed.

6. The composition of claim 1, wherein component (iii) additionally comprises titanium dioxide.

7. A polyethylene resin composition prepared by the process comprising:
(a) preparing a mixture by admixing the following components:
(i) about 60% polyethylene,
(ii) about 12% of a linear low density polyethylene prepared using a metallocene catalyst,
(iii) about 3% of a low density polyethylene comprising about 60% by weight titanium oxide, and
(iv) about 25% of a high density polyethylene having a density of about 0.950-0.960 and an MFR of about 0.03-0.05; and
(b) heating the mixture at a temperature of not more than about 120° C. for about one hour.

8. A method of preparing a polyethylene composition comprising:
(a) preparing a mixture by admixing the following components:
(i) about 40-80% polyethylene,
(ii) about 5-30% of a linear low density polyethylene prepared using a metallocene catalyst,
(iii) about 1-10% of a low density polyethylene, and
(iv) about 10-30% of a high density polyethylene; and
(b) heating the mixture at a temperature in the range of 80-120° C. for a range of 0.45-1.5 hours.

9. The method of claim 8, wherein about 50-75% of component (i) is employed.

10. The method of claim 8, wherein about 10-20% of component (ii) is employed.

11. The method of claim 8, wherein about 1-5% of component (iii) is employed.

12. The method of claim 8, wherein about 20-25% of component (iv) is employed.

13. The method of claim 8, wherein component (iii) additionally comprises titanium dioxide.

14. A method of preparing a polyethylene composition comprising:
(a) preparing a mixture by admixing the following components:
(i) about 60% polyethylene,
(ii) about 12% of a linear low density polyethylene prepared using a metallocene catalyst,
(iii) about 3% of a low density polyethylene comprising about 60% by weight titanium oxide, and
(iv) about 25% of a high density polyethylene having a density of about 0.950-0.960 and an MFR of about 0.03- 0.05; and
(b) heating the mixture at a temperature of not more than about 120° C. for about one hour.

15. A polyethylene film composition prepared by the process comprising:
(a) preparing a mixture by admixing the following components:
(i) about 40-80% polyethylene
(ii) about 5-30% of a linear low density polyethylene prepared using a metallocene catalyst,
(iii) about 1-10% of a low density polyethylene, and
(iv) about 10-30% of a high density polyethylene;
(b) heating the mixture at a temperature in the range of 80-120° C. for a range of 0.45-1.5 hours; and
(c) introducing the mixture into a blown film apparatus and processing the mixture at a temperature in the range of 180-210° C. to obtain a polyethylene film having an elongation greater than 500 wherein said film is suitable for use as a substitute for paper.

16. The composition of claim 15, wherein about 50-75% of component (i) is employed.

17. The composition of claim 15, wherein about 10-20% of component (ii) is employed.

18. The composition of claim 15, wherein about 1-5% of component (iii) is employed.

19. The composition of claim 15, wherein about 20-25% of component (iv) is employed.

20. The composition of claim 15, wherein component (iii) additionally comprises titanium dioxide.

21. (Twice Amended) A polyethylene film composition prepared by the process comprising:
(a) preparing a mixture by admixing the following components:
(i) about 60% polyethylene having a density greater than 0.980 g/cc,
(ii) about 12% of a linear low density polyethylene prepared using a metallocene catalyst,
(iii) about 3% of a low density polyethylene comprising about 60% by weight titanium oxide, and
(iv) about 25% of a high density polyethylene having a density of about 0.950-0.960 and an MFR of about 0.03-0.05; and
(b) heating the mixture at a temperature of not more than about 120° C. for about one hour; and
(c) introducing the mixture into a blown film apparatus and processing the mixture at a temperature in the range of 180-210° C. to obtain a polyethylene film having an elongation greater than 500 wherein said film is suitable for use as a substitute for paper.

22. A method of preparing a polyethylene film composition comprising:
(a) preparing a mixture by admixing the following components:
(i) about 40-80% polyethylene
(ii) about 5-30% of a linear low density polyethylene prepared using a metallocene catalyst,
(iii) about 1-10% of a low density polyethylene, and
(iv) about 10-30% of a high density polyethylene;
(b) heating the mixture at a temperature in the range of 80-120° C. for a range of 0.45-1.5 hours; and
(c) introducing the mixture into a blown film apparatus and processing the mixture at a temperature in the range of 180-210° C. to obtain a polyethylene film having an elongation greater than 500 wherein said film is suitable for use as a substitute for paper.

23. The composition of claim 22, wherein about 50-75% of component (i) is employed.

24. The composition of claim 22, wherein about 10-20% of component (ii) is employed.

25. The composition of claim 22, wherein about 1-5% of component (iii) is employed.

26. The composition of claim 22, wherein about 20-25% of component (iv) is employed.

27. The composition of claim 22, wherein component (iii) additionally comprises titanium dioxide.

28. The method of claim 22, wherein a tube-shaped die is employed in the blown film apparatus.

29. A method of preparing a polyethylene film composition comprising:
(a) preparing a mixture by admixing the following components:
(i) about 60% polyethylene
(ii) about 12% of a linear low density polyethylene prepared using a metallocene catalyst,
(iii) about 3% of a low density polyethylene comprising about 60% by weight titanium dioxide, and
(iv) about 25% of a high density polyethylene having a density of about 0.950-0.960 and an MFR of about 0.03-0.05;
(b) heating the mixture at a temperature of not more than 120° C. for about one hour;
and
(c) introducing the mixture into a blown film apparatus and processing the mixture at a temperature in the range of 180-210° C. to obtain a polyethylene film having an elongation of greater than 500 wherein said film is suitable for use as a substitute for paper.

30. The method of claim 29, wherein a tube-shaped die is employed in the blown film apparatus.
